(19) United States
(12) Patent Application Publication
(10) Pub. No.: US 2024/0127582 A1
(43) Pub. Date: Apr. 18, 2024

(54) Method and system for classification of objects in images

(71) Applicant: Marduk Technologies OÜ, Tallinn (EE)

(72) Inventors: Toomas Pruuden, Tallinn (EE); Martin Simon, Tallinn (EE); Simon Wenkel, Tallinn (EE)

(21) Appl. No.: 18/277,526

(22) PCT Filed: Feb. 18, 2022
(86) PCT No.: PCT/EP2022/054111

§ 371 Date: Aug. 16, 2023

(30) Foreign Application Priority Data
Feb. 19, 2021 (EP) 21158274.7

(51) Int. Cl. G06V 10/764; G06V 10/60; G06V 10/74; G06V 20/70

(52) U.S. Cl. CPC G06V 10/764; G06V 10/60; G06V 10/761; G06V 20/70; G06V 2201/07

(57) ABSTRACT

A method for classification of objects in images includes obtaining a plurality of temporally sequential images; detecting at least one object of interest in the images; matching at least one detected object of interest across the plurality of the images; applying variance analysis on the object between the temporally sequential images; and based on variance analysis output, assigning at least one label to the object of interest.

### FIELD

The invention relates to classifying detected objects in images. More specifically, the invention relates to analyzing sequential images and labelling objects of interest in them.

### INTRODUCTION

Analyzing and processing images is important in many aspects of present life. Particularly, detecting and identifying objects or objects of interest in images or video taken by a camera is used in several applications such as autonomous driving, robotics, security or surveillance. For applications focusing on security and/or defense, identifying objects such as persons can be of particular importance.

Some ways of identifying and tracking objects in images are explored in the art. For example, U.S. Pat. No. 7,450,735 B1 discloses tracking and surveillance methods and systems for monitoring objects passing in front of non-overlapping cameras. Invention finds corresponding tracks from different cameras and works out which object passing in front of the camera(s) made the tracks, in order to track the object from camera to camera. The invention uses an algorithm to learn inter-camera spatial temporal probability using Parzen windows, learns inter-camera appearance probabilities using distribution of Bhattacharyya distances between appearance models, establishes correspondences based on Maximum A Posteriori (MAP) framework combining both spatial temporal and appearance probabilities, and updates learned probabilities throughout the lifetime of the system.

Furthermore, U.S. Pat. No. 9,613,277 B2 discloses a method for surveilling a monitored environment that includes classifying an individual detected in the monitored environment according to a role fulfilled by the individual within the monitored environment, generating a trajectory that illustrates movements and locations of the individual within the monitored environment, and detecting when the trajectory indicates an event that is inconsistent with an expected pattern for the role.

Identifying persons or other living objects (e.g. animals such as dogs) has also been explored in the prior art. For instance, international patent application WO 2013/160688 A1 describes methods and apparatus for determining whether a provided object track is abnormal, an object track being a set of values of a physical property of an object measured over a period of time. The method comprises: providing a model comprising one or more functions, each function being representative of an object track that is defined to be normal; assigning the provided object track to a function; and comparing the provided object track to the assigned function to determine whether that object track is abnormal. Providing the model comprises: for each of a plurality of objects, determining an object track, wherein the determined object tracks are defined as normal object tracks; and using the determined tracks, performing a Gaussian Processes based Variational Bayes Expectation Maximization process to learn the one or more functions.

Similarly, U.S. Pat. No. 8,948,450 B2 describes a method and system for automatic object detection and subsequent object tracking in accordance with the object shape in digital video systems having at least one camera for recording and transmitting video sequences. In accordance with the method and system, an object detection algorithm based on a Gaussian mixture model and expanded object tracking based on Mean-Shift are combined with each other in object detection. The object detection is expanded in accordance with a model of the background by improved removal of shadows, the binary mask generated in this way is used to create an asymmetric filter core, and then the actual algorithm for the shape-adaptive object tracking, expanded by a segmentation step for adapting the shape, is initialized, and therefore a determination at least of the object shape or object contour or the orientation of the object in space is made possible.

U.S. Pat. No. 7,391,907 B1 discloses a system that detects an object in frames of a video sequence to obtain a detected object, tracks the detected object in the frames of the video sequence to obtain a tracked object, and classifies the tracked object as a real object or a spurious object based on spatial and/or temporal properties of the tracked object.

U.S. Pat. No. 7,639,840 B2 describes a method and apparatus for video surveillance. In one embodiment, a sequence of scene imagery representing a field of view is received. One or more moving objects are identified within the sequence of scene imagery and then classified in accordance with one or more extracted spatio-temporal features. This classification may then be applied to determine whether the moving object and/or its behavior fits one or more known events or behaviors that are causes for alarm.

Similarly, U.S. Pat. No. 8,520,899 B2 presents techniques for classifying one or more objects in at least one video, wherein the at least one video comprises a plurality of frames. One or more objects in the plurality of frames are tracked. A level of deformation is computed for each of the one or more tracked objects in accordance with at least one change in a plurality of histograms of oriented gradients for a corresponding tracked object. Each of the one or more tracked objects is classified in accordance with the computed level of deformation.

### SUMMARY

It is the object of the present invention to provide an improved and robust way of classifying objects in images. It is further the object of the invention to disclose labeling objects detected in sequential images or frames, particularly by performing variance analysis. Further, methods and systems related to classifying and labeling objects of interest for surveillance purposes are disclosed.

A method and a system for classification of objects in images according to the present invention can comprise the steps discussed in the following and a component configured for performing those steps, respectively.

An obtaining of a plurality of temporally sequential images can take place. This can be done by an image detector and/or image storage. The image detector can be an pixel array image sensor, a camera with an pixel array image sensor etc. The images can also be taken before and provided from a storage for the object classification. The detecting is attempted in each of the images. The matching of at least one detected object of interest across the plurality of the images can take place. Also, an applying of a variance analysis on the object between the temporally sequential images can be part of the invention. Based on variance analysis output, at least one label to the object of interest can be further assigned according to the invention.

Moreover, in each image the object of interest is in fact detected.

The label identifies the object as at least one of an animate object and/or an inanimate object. One of the fields of application could be the detection and/or clearance of the aerial space from unauthorized and unmanned aerial vehicles (UAVs), such as drones.

These objects are usually maneuvering fast and it is an advantage of the invention to cope with this is an efficient manner.

The animate object comprises a bird or another object or can be tolerated in protected areas or aerial space, such as airports etc.

A variance analysis can comprise an Albedo variance analysis or more specifically a surface Albedo variance analysis. In this respect it is referred to https://en.wikipedia.org/wiki/Albedo of February 2021, herein incorporated by reference. Generally, Albedo corresponds to the measure of the diffuse reflection of an object's radiation out of the total radiation and can be measured on a scale from 0, corresponding to a black body that absorbs all incident radiation, to 1, corresponding to a body that reflects all incident radiation. Surface albedo is defined as the ratio of radiosity to the irradiance (flux per unit area) received by a surface. The proportion reflected is not only determined by properties of the surface itself, but also by the spectral and angular distribution of radiation. Reference is made to state.edu/˜parent.1/classes/782/Lectures/03_Radiometry. pdf, http://www2.hawaii.edu/˜jmaurer/albedo/ and/or https://www.researchgate.net/publication/248804810 Analysis_of_the_in_situ_and_MODIS_albedo_variability_at_multiple_time_scales_in_the_Sahel_-_art_no_D14119, all having been available February 2021 and incorporated herein by reference.

The images can be captured by image sensors and the variance analysis can comprises the detection and/or measurement of light and/or light reflection by the image sensors over time.

The images can be provided in real time, quasi-real time and/or by a storage.

The images can be provided by a camera or any other appropriate device of assembly of devices. The camera can comprise an image sensor, such as a digital image sensor.

The differentiation between the animate object and the inanimate object can be performed by the Albedo variance analysis of images caused by morphing or unmorphing shapes. The Albedo variance analysis can be also or alternatively performed in a static and/or time-dependent manner and/or in a periodic and/or statistical manner.

The variance analysis can be trained with the assistance of a deep learning neural network for providing the label or an appropriate label or used in the already trained fashion.

Prior to obtaining the images, recording a video of surroundings can be done with at least one camera, and wherein the temporally sequential images comprise consecutive frames of the video.

Analyzing change in the object of interest shape between the images as part of the variance analysis can be performed.

Alternatively or additionally, analyzing a movement pattern of the object of interest across the plurality of images as part of the variance analysis can be automatically performed. Also, several moving patterns and/or a combination of moving patterns can be used.

In order to improve the result, regression modeling as part of the variance analysis can be used as well. Further, a neural network as part of the variance analysis can be applied.

The variance analysis can be trained by a convolutional neural network (CNN) for providing the label. The result of this training can then be used as a further tool.

The step of obtaining a plurality of temporally sequential images can comprise the step of tracking and following the object in an automated manner. This is an advantage of the present invention as speed and reaction time are important to properly follow an object, particularly in case the object is trying to behave in an unpredictable manner.

The step of obtaining a plurality of temporally sequential images can comprise the step of tracking and following the object in an automated manner by a camera that is configured to move accordingly.

The step of obtaining a plurality of temporally sequential images can comprise the step of tracking and following the object in an automated manner by a camera that is adjusted in its location and configured to move. The adjustment can be a temporary or constant adjustment. A temporary adjustment could, e.g., be done on a tripod. A constant adjustment could be an adjustment to a building or any constant structure.

The step of obtaining a plurality of temporally sequential images can comprise the step of tracking and following the object in an automated manner by a camera that is configured to move in position and to tilt and turn according to the tracked object.

The step of obtaining a plurality of temporally sequential images can comprise the step of tracking and following the object in an automated manner by a camera with an adjustable focal length.

The adjustable focal length can be realized by a zoom lens and/or a switchable set of lenses. The set of lenses can be prime lenses and/or zoom lenses. In case they can be switched, a revolver-like arrangement can be used.

The step of tracking and following the object in an automated manner by a camera and by automatically adjusting the focal length and/or by automatically switching a plurality of lenses can be done according to the distance of the object tracked.

Also, the step of irritating and/or destroying the object of interest in case an inanimate object is identified can be provided. This can be done by a laser effector or actuator or canon. The laser or other effector and the camera can be coupled, such as in a fixed manner.

A triggering of the laser effector to emit a laser beam onto the object of interest in case an inanimate object is detected can be provided.

A controlling one or more or all of the steps by a computer can be provided as well. The computer can comprise at least one of a remote and/or a local component(s). The computation can be performed in a central, decentral or distributed manner. A remote component can be arranged with a distance to the location of the other components and, e.g., can be based on a cloud solution. It can also be a central server etc. The remote component of the computer can be configured to store the images and/or to train the assigning of the at least one label to the object of interest. The latter can be advantageous as the training needs a lot of computing power or parallel processing that may not be needed locally.

The remote component of the computer can be configured to transfer the trained assigning of the at least one label to the local component of the computer. This can be initiated by the remote and/or the local component of the computer.

The local component of the computer can be configured to control the obtaining of the images and/or can configured to control the obtaining of the images.

The local component of the computer can be configured to control the camera, either alternatively or additionally.

A system in accordance with the present invention further comprises the components, assemblies etc. that allow the steps mentioned before.

The label identifying the object labels can be at least one of an animate object and an inanimate object. In the pre-dominant number of cases only one of these species is present. However, it can happen that both is present, such as a bird and a drone.

The variance analysis can comprise an Albedo variance analysis. The images can be captured by pixel array image sensors and the variance analysis can comprises the detection and/or measurement of light and/or light reflection by the pixel array image sensors over time.

The images may be provided by a storage or a buffer in case the images are already captured.

The images can be provided by a camera in a more direct manner.

Pixel array image sensors that can be part of a camera or other image capturing devices can differentiate between the animate object and the inanimate object.

The differentiation between the animate object and the inanimate object can be performed by the Albedo variance analysis, preferably caused by morphing or un-morphing shapes or the path shape of the object. The Albedo variance analysis can be performed in a static and/or time-dependent manner also. Additionally or alternatively, the Albedo variance analysis can be performed in a periodic and/or statistical manner.

The variance analysis can be trained by a convolutional neural network (CNN) for providing the label. The method and the system with the training process are part of the invention as well as the already trained variance analysis.

Prior to obtaining the images, a recording a video of surroundings with at least one camera, and wherein the temporally sequential images comprise consecutive frames of the video.

Analyzing the change in the object of interest shape between the images can take place as part of the variance analysis.

Analyzing a movement pattern of the object of interest across the plurality of images can be part of the variance analysis.

The present invention can also use regression modeling as part of the variance analysis. This can be done by using a neural network as part of the variance analysis. The variance analysis can be trained by a convolutional neural network (CNN) for providing the label. Other alternative ways of training can be used as well.

The step of obtaining a plurality of temporally sequential images can comprise the step of tracking and following the object in an automated manner. That can be done by a camera that is configured to move accordingly. The camera can be adjusted in its location and can be configured to move.

The step of obtaining a plurality of temporally sequential images can comprise the step of tracking and following the object in an automated manner by a camera that can be configured to move in position and to tilt and turn according to the tracked object.

The step of obtaining a plurality of temporally sequential images can comprise the step of tracking and following the object in an automated manner by a camera with an adjustable focal length. The adjustable focal length can be realized by a zoom lens and/or a switchable set of lenses.

The present invention can also embrace software that is controlling one of more computers or components thereof to perform the method as specified in the present specification.

### EMBODIMENTS

Below is a list of method embodiments. Those will be indicated with a letter “M”. Whenever such embodiments are referred to, this will be done by referring to “M” embodiments.

M1. A method for classification of objects in images, the method comprising obtaining a plurality of temporally sequential images;
detecting at least one object of interest in the images;
matching at least one detected object of interest across the plurality of the images;
applying variance analysis on the object between the temporally sequential images; and based on variance analysis output, assigning at least one label to the object of interest.

M2. The method according to any one of the preceding method embodiments wherein the label identifies the object as at least one of an animate object; and an inanimate object (20).

M3. The method according to any one of the preceding method embodiments wherein the inanimate object comprises an unmanned aerial vehicle (20), such as a drone (20).

M4. The method according to any one of the preceding method embodiments wherein the animate object comprises a bird.

M5. The method according to any of the preceding method embodiments wherein the variance analysis comprises an Albedo variance analysis.

M6. The method according to any of the preceding method embodiments wherein the variance analysis comprises a surface Albedo variance analysis.

M7. The method according to any of the preceding method embodiments wherein the images are captured by pixel array image sensors and the variance analysis comprises the detection and/or measurement of light and/or light reflection by the pixel array image sensors over time.

M8. The method according to any of the preceding method embodiments wherein one or more steps are computed by at least one computer configured for computation in a central, decentral and/or distributed manner.

M9. The method according to any of the preceding method embodiments wherein the images are provided by a storage (40).

M10. The method according to any of the preceding method embodiments wherein the images are provided by a camera (32).

M11. The method according to the preceding method embodiment wherein the camera (32) comprises a pixel array image sensor (33).

M12. The method according to any of the preceding method embodiments wherein the differentiation between the animate object and the inanimate object is performed by the Albedo variance analysis, preferably caused by morphing or unmorphing shapes.

M13. The method according to any of the preceding method embodiments wherein the Albedo variance analysis can be performed in time-dependent manner.

M14. The method according to any of the preceding method embodiments wherein the Albedo variance analysis can be performed in a periodic and/or statistical manner.

M15. The method according to any of the preceding method embodiments with the further step of training the variance analysis by a deep learning neural network for providing the label.

M16. The method according to any of the preceding method embodiments wherein the variance analysis has been trained by a deep learning neural network for providing the label.

M17. The method according to any of the preceding method embodiments further comprising, prior to obtaining the images, recording a video of surroundings with at least one camera, and wherein the temporally sequential images comprise consecutive frames of the video.

M18. The method according to any of the preceding method embodiments further comprising analyzing change in the object of interest shape between the images as part of the variance analysis.

M19. The method according to any of the preceding method embodiments further comprising analyzing one or more movement pattern(s) of the object of interest across the plurality of images as part of the variance analysis.

M20. The method according to any of the preceding method embodiments further comprising using regression modeling as part of the variance analysis.

M21. The method according to any of the preceding method embodiments further comprising using a neural network as part of the variance analysis.

M22. The method according to any of the preceding method embodiments wherein the variance analysis has been trained by a convolutional neural network (CNN) for providing the label.

M23. The method according to any of the preceding method embodiments wherein the step of obtaining a plurality of temporally sequential images comprises the step of tracking and following the object in an automated manner.

M24. The method according to any of the preceding method embodiments wherein the step of obtaining a plurality of temporally sequential images comprises the step of tracking and following the object in an automated manner.

M25. The method according to any of the preceding method embodiments wherein the step of obtaining a plurality of temporally sequential images comprises the step of tracking and following the object in an automated manner by a camera that is configured to move accordingly.

M26. The method according to any of the preceding method embodiments wherein the step of obtaining a plurality of temporally sequential images comprises the step of tracking and following the object in an automated manner by a camera that is adjusted in its location and configured to move.

M27. The method according to any of the preceding method embodiments wherein the step of obtaining a plurality of temporally sequential images comprises the step of tracking and following the object in an automated manner by a camera that is configured to move in position and to tilt and turn according to the tracked object.

M28. The method according to any of the preceding method embodiments wherein the step of obtaining a plurality of temporally sequential images comprises the step of tracking and following the object in an automated manner by a camera with an adjustable focal length.

M29. The method according to the preceding method embodiments wherein the adjustable focal length can be realized by a zoom lens and/or a switchable set of lenses.

M30. The method according to any of the preceding method embodiments further with the step of tracking and following the object in an automated manner by a camera and by automatically adjusting the focal length and/or by automatically switching a plurality of lenses according to the distance of the object tracked.

M31. The method according to any of the preceding method embodiments further comprising the step of irritating and/or destroying the object of interest in case an inanimate object (20) is identified.

M32. The method according to the preceding method embodiment wherein the irritating and/or destroying of the object of interest (20) is done by a laser effector (33).

M33. Method according to any of the two preceding method embodiments with the further step of targeting the laser or other effector (33) onto the object of interest.

M34. The method according to the preceding method embodiment wherein the laser effector (33) and the camera (32) can be coupled.

M35. The method according to the preceding method embodiment wherein the laser effector (33) and the camera (32) can be coupled in a fixed manner.

M36. The method according to any of the five preceding method embodiment with the further step of triggering the laser effector (33) to emit a laser beam onto the object of interest in case an inanimate object is detected.

M37. The method according to any of the preceding method embodiments with the further step of controlling one or more or all of the steps by a computer (40).

M38. The method according to the preceding method embodiment wherein the computer (40) comprises at least one of a remote and/or a local component(s).

M39. The method according to the preceding method embodiment wherein the remote component of the computer (40) is configured to store the images.

M40. The method according to any of the two preceding method embodiments wherein the remote component of the computer (40) is configured to train the assigning of the at least one label to the object of interest.

M41. The method according to the preceding method embodiment wherein the remote component of the computer (40) is configured to transfer the trained assigning of the at least one label to the local component of the computer (40).

M42. The method according to any of the four preceding method embodiments wherein the local component of the computer (40) is configured to control the obtaining of the images.

M43. The method according to any of the three preceding method embodiments wherein the local component of the computer (40) is configured to control the obtaining of the images.

M44. The method according to any of the four preceding method embodiments wherein the local component of the computer (40) is configured to control the camera (32).

Below is a list of system embodiments. Those will be indicated with a letter “5”. Whenever such embodiments are referred to, this will be done by referring to “5” embodiments.

S1. A system for classification of objects in images, the system being configured to obtain a plurality of temporally sequential images;
to detect at least one object of interest in the images;
match at least one detected object of interest across the plurality of the images;
apply variance analysis on the object between the temporally sequential images; and
based on variance analysis output, assign at least one label to the object of interest.

S2. The system according to any one of the preceding system embodiments wherein the label identifies the object as at least one of
an animate object; and
an inanimate object (20).

S3. The system according to any one of the preceding system embodiments wherein the inanimate object comprises an unmanned aerial vehicle (20), such as a drone (20).

S4. The system according to any one of the preceding system embodiments wherein the animate object comprises a bird.

S5. The system according to any of the preceding system embodiments wherein the variance analysis comprises an Albedo variance analysis.

S6. The system according to any of the preceding system embodiments wherein the variance analysis comprises a surface Albedo variance analysis.

S7. The system according to any of the preceding system embodiments wherein the images are captured by pixel array image sensors and the variance analysis comprises the detection and/or measurement of light and/or light reflection by the pixel array image sensors over time.

S8. The system according to any of the preceding system embodiments wherein the images are provided by a storage (40).

S9. The system according to any of the preceding system embodiments wherein the images are provided by a camera (32).

S10. The system according to the preceding system embodiment wherein the camera (32) comprises a pixel array image sensor (33).

S11. The system according to any of the preceding system embodiments further comprising at least one computer configured for computation in a central, decentral and/or distributed manner.

S12. The system according to any of the preceding system embodiments wherein the system is configured so that the differentiation between the animate object and the inanimate object is performed by the Albedo variance analysis, preferably caused by morphing or unmorphing shapes.

S13. The system according to any of the preceding system embodiments wherein the Albedo variance analysis can be performed in a static and/or time-dependent manner.

S14. The system according to any of the preceding system embodiments wherein the Albedo variance analysis can be performed in a periodic and/or statistical manner.

S15. The system according to any of the preceding system embodiments wherein the variance analysis has been trained by a convolutional neural network (CNN) for providing the label.

S16. The system according to any of the preceding system embodiments further comprising, prior to obtaining the images, a component for recording a video of surroundings with at least one camera, and wherein the temporally sequential images comprise consecutive frames of the video.

S17. The system according to any of the preceding system embodiments further comprising a component for analyzing change in the object of interest shape between the images as part of the variance analysis.

S18. The system according to any of the preceding system embodiments further comprising a component for analyzing one or more movement pattern(s) of the object of interest across the plurality of images as part of the variance analysis.

S19. The system according to any of the preceding system embodiments further comprising a component using regression modeling as part of the variance analysis.

S20. The system according to any of the preceding system embodiments further comprising a neural network as part of the variance analysis.

S21. The system according to any of the preceding system embodiments wherein the variance analysis has been trained by a deep learning neural network for providing the label.

S22. The system according to any of the preceding system embodiments wherein a component for obtaining a plurality of temporally sequential images comprises is configured for tracking and following the object in an automated manner.

S23. The system according to any of the preceding system embodiments wherein a component for obtaining a plurality of temporally sequential images is configured for tracking and following the object in an automated manner.

S24. The system according to any of the preceding system embodiments wherein a component for obtaining a plurality of temporally sequential images is further configured to track and follow the object in an automated manner by a camera is configured to move accordingly.

S25. The system according to any of the preceding system embodiments wherein a component for obtaining a plurality of temporally sequential images comprises the step of tracking and following the object in an automated manner by a camera is adjusted in its location and configured to move.

S26. The system according to any of the preceding system embodiments wherein a component for obtaining a plurality of temporally sequential images is configured for tracking and following the object in an automated manner by a camera is configured to move in position and to tilt and turn according to the tracked object.

S27. The system according to any of the preceding system embodiments wherein a component for obtaining a plurality of temporally sequential images is configured for tracking and following the object in an automated manner by a camera with an adjustable focal length.

S28. The system according to the preceding system embodiments wherein the adjustable focal length can be realized by a zoom lens and/or a switchable set of lenses.

S29. The system according to any of the preceding system embodiments further with a component for tracking and following the object in an automated manner by a camera and by automatically adjusting the focal length and/or by automatically switching a plurality of lenses according to the distance of the object tracked.

S30. The system according to any of the preceding system embodiments further comprising a component for irritating and/or destroying the object of interest in case an inanimate object (20) is identified.

S31. The system according to the preceding system embodiment wherein the irritating and/or destroying of the object of interest (20) is done by a laser effector (33).

S32. The system according to any of the two preceding system embodiments with a component for targeting the laser effector (33) onto the object of interest.

S33. The system according to the preceding system embodiment wherein the laser effector (33) and the camera (32) are configured to be coupled.

S34. The system according to the preceding system embodiment wherein the laser effector (33) and the camera (32) are configured to be coupled in a fixed manner.

S35. The system according to any of the five preceding system embodiments with a component for triggering the laser effector (33) to emit a laser beam onto the object of interest in case an inanimate object is detected.

S36. The system according to any of the preceding system embodiments with a component for controlling one or more or all of the steps by a computer (40).

S37. The system according to the preceding system embodiment wherein the computer (40) comprises at least one of a remote and/or a local component(s).

S38. The system according to the preceding system embodiment wherein the remote component of the computer (40) is configured to store the images.

S39. The system according to any of the two preceding system embodiments wherein the remote component of the computer (40) is configured to train the assigning of the at least one label to the object of interest.

S40. The system according to the preceding system embodiment wherein the remote component of the computer (40) is configured to transfer the trained assigning of the at least one label to the local component of the computer (40).

S41. The system according to any of the four preceding system embodiments wherein the local component of the computer (40) is configured to control the obtaining of the images.

S42. The system according to any of the three preceding system embodiments wherein the local component of the computer (40) is configured to control the obtaining of the images.

S43. The system according to any of the four preceding system embodiments wherein the local component of the computer (40) is configured to control the camera (32).

Below, use embodiments will be discussed. These embodiments are abbreviated by the letter “U” followed by a number. Whenever reference is herein made to “use embodiments”, these embodiments are meant.

U1. Use of the system according to any of the preceding system embodiments for carrying out the method according to any of the preceding method embodiments.

U2. Use of the system according to any of the preceding embodiments for controlling the aerial space.

U3. Use of the system according to any of the preceding embodiments for clearing the aerial space from unauthorized unmanned aerial vehicles, such as drones.

Below, program embodiments will be discussed. These embodiments are abbreviated by the letter “P” followed by a number. Whenever reference is herein made to “program embodiments”, these embodiments are meant.

P1. A computer program product comprising instructions, which, when the program is executed on a computer (40), causes the computer to perform the method steps according to any of the preceding method embodiments.

P2. A computer program product comprising instructions, which, when the program is used on a computer (40), causes the computer to train the method according to any of the preceding method embodiments.

P3. A computer program product comprising instructions, which, when the program is used on a computer (40), causes the computer to perform the trained method according to any of the preceding method embodiments.

The present technology will now be discussed with reference to the accompanying drawings.

### BRIEF DESCRIPTION OF THE DRAWINGS

FIG. 1 schematically depicts an embodiment of a method for classifying objects in images according to an embodiment of the present invention.

FIG. 2 presents an exemplary embodiment of an object of interest detected in several images according to an embodiment of the invention.

FIG. 3 shows an example of a bird against a drone signature difference detected by Albedo variance analysis.

FIG. 4 schematically illustrates using a neural network to analyze motion data components as per FIG. 3 and to output object labels.

FIG. 5 shows a principal arrangement of components in accordance with the present invention.

### DESCRIPTION OF EMBODIMENTS

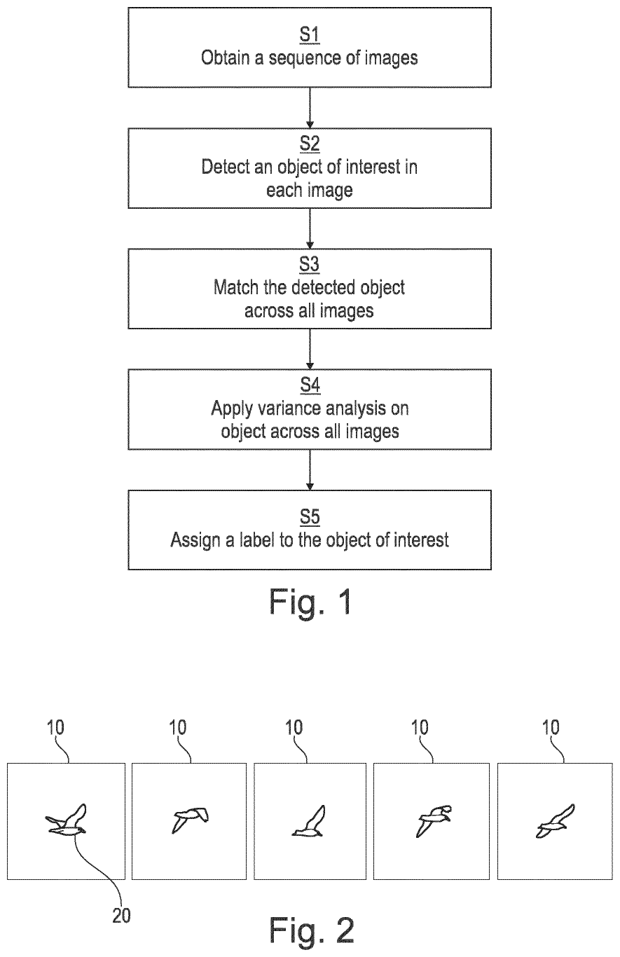

FIG. 1 schematically outlines an embodiment of image classification method as per an aspect of the present invention.

In a first step, a sequence of images is obtained. The images may be taken by one or more cameras and may comprise sequential images taken at subsequent points of time and/or subsequent frames of a video recorded by one or more cameras. In a preferred embodiment, the images may be recorded or captured by a camera for surveillance purposes.

In step S2, an object of interest is detected in each image. The object of interest may be detected by typical object detection algorithms.

Following that, the detected object is matched across all images in S3. In other words, a given object of interest is identified as one and the same in each of the images where it is present.

The images and particularly the detected object of interest is then analyzed by using variance analysis. For example, albedo variance may be used. In some preferred embodiments, a neural network may receive the images and/or the detected objects of interest as input and analyze them based on their variance. The variance analysis may be performed over time-variant raster and/or via multispectral data.

In step S5, the object is assigned a label. The label may identify the object as belonging to a certain type or category of objects. In a preferred embodiment, the label may identify the object as animate (such as e.g. a person, a dog, a cat, a bird) or inanimate (such as e.g. drone, autonomous robot, balloon, aircraft, or the like).

The method can be also advantageously used for surveillance purposes to reliably identify intruders or surveillance devices such as drones. The use of variance analysis allows to extract better results from images that may be of low quality (when e.g. the object of interest is far away from the camera).

It can be an additional or alternative advantage of the present invention to distinguish between animate and inanimate objects. This allows for different control or trigger signals for a further treatment considered appropriate for the inanimate object. In case of a drone, the system can then be activated for defending against a drone or for even inactivating the drone, e.g. by a laser.

FIG. 2 shows an example of an object of interest detected in a plurality of images 10. The object of interest 20 (in this case, a bird) presents various shapes as its motion pattern unfolds across the sequential images 10 (i.e. as the bird flies and moves its wings and body). As is further apparent, the background of the image can vary regarding contrast, resolution, noise, color etc. Using a variance-type analysis on the images may allow to identify the bird as an animate object as opposed to, e.g., a drone, which would have a motion pattern that would be much more regular.

The bird cut outs shown in FIG. 2 constitutes a bird Albedo variation example 10 wherein by Albedo variance analysis a bird is detected in contrast to an inanimate example, such as a drone.

Albedo is based on the reflection of light. By Albedo variance it is intended to mean the reflection of light towards the pixel array sensors over time, which is different depending on an object type.

Just as an example: birds flap their wings and have shape morphing, which causes different Albedo when compared to that of a drone rotation/movement/section dependent variation.

The difference can be temporal, meaning a time-dependent or a static frame. A time-dependent or temporal analysis can be modelled or detected by a periodic and a statistical analysis.

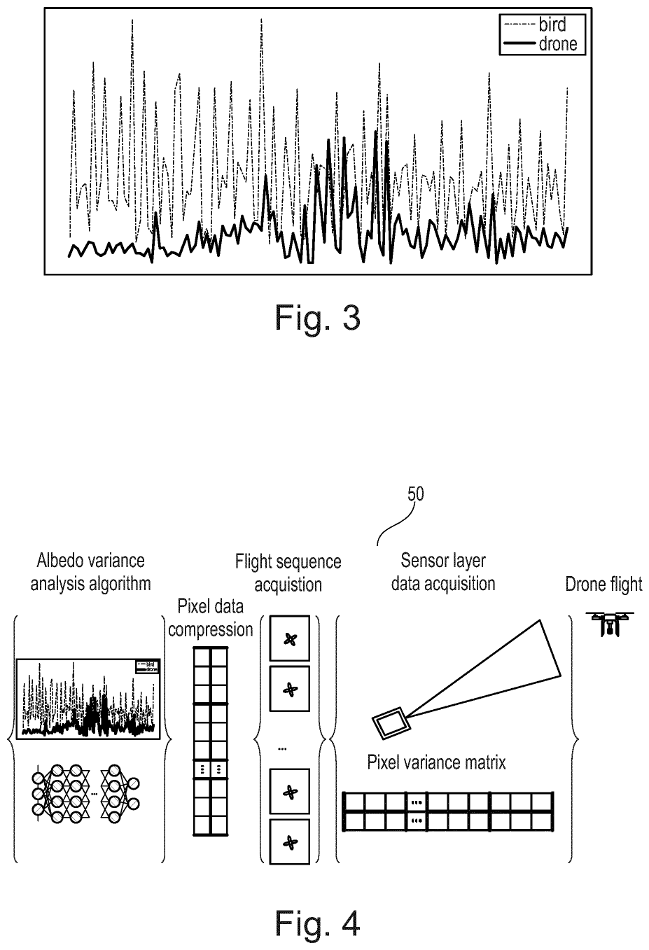

A partial example is visualized in FIG. 3. A spectator could see at far something flying but cannot really tell what it is. At some point the spectator gets an impression that it is a bird by the way the shape morphs and the flight pattern it creates. Through Albedo variance analysis we make this effect machine-readable. The Albedo analysis results showing the amount of reflected light over time shows a difference that can be taken for training the classification model.

The graphs in FIG. 3 can be tracked and taken for the analysis and/or training of the model. This can be a convolutional neural network (CNN). The CNN computes this information after seeing a few times drones and birds flying very far away it can distinguish between a drone and what is a bird/tree/airplane/etc.

CNN-s are essentially statistical methods, which try to distribute data in a way, which makes it most probable to give a correct classification. The CNN parameters can be tuned, re-created and/or altered.

FIG. 4 shows a schematic depiction of a variance analysis of an object of interest, e.g., by using a neural network.

For that a drone 20 is captured by an optical pixel array sensor through an optical system (not shown) and then transferred into a pixel variance matrix. This constitutes the sensor layer data acquisition.

Several sequences—in this case of the flight of a drone 20—are captured and acquired in a flight sequence acquisition phase.

The pixel array data is then compressed in order to allow a faster and/or more affordable computation of the data and via an Albedo variance analysis algorithm analyzed in order to determine the kind of flight object—in this case the drone 20.

The motion data component distribution is input into a convolutional neural network, and a label for the object in question is output.

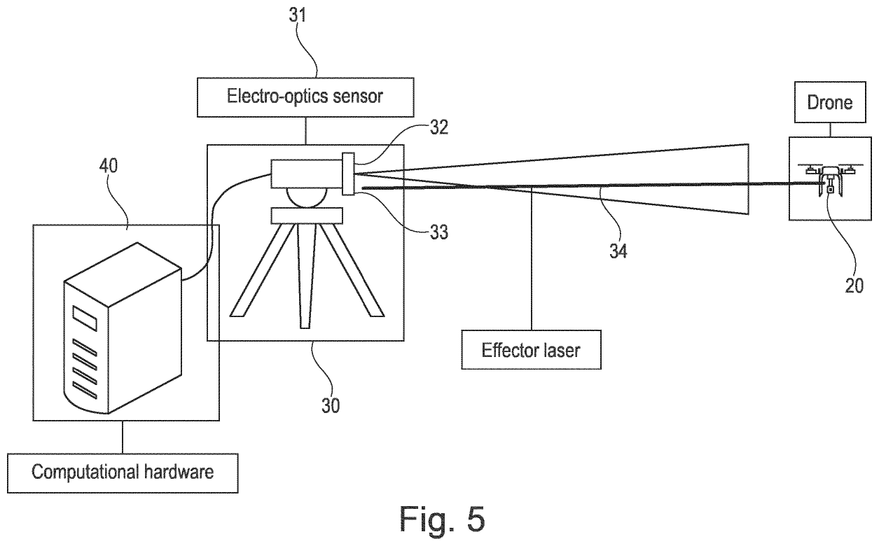

In FIG. 5 a principal setup of some hardware components during operation are shown. An assembly 30 is shown with a camera 32 comprising an optical pixel array sensor 31. The camera is configured to be able to capture a frame of a flying object, advantageously also over greater distances. For that reason, the camera 32 can be arranged on a tripod or can be fixedly arranged in order to allow a stable image capturing. The camera can also comprise one or more lenses with fixed and/or adjustable focal lengths. An adjustable lens can be adjusted in focal length and/or a plurality of lenses can be switched automatically according to the distance of the flying object.

Further an effector 33 can emit and effector beam 34 in order to irritate and/or destroy the drone 20 or any parts thereof, such as the controller or parts of the controller, such as the navigation sensor. In the example shown, the effector is a laser effector 33 emitting a laser 34 of sufficient power.

A computer 40 can be provided in order to control the system and the method in accordance with the present invention. For the sake of brevity, the figure just shows one computer 40. However, this can be configured by a number of computers or computer components.

It can be advantageous to have a local computer component in order to control the camera and the laser device in order to avoid any latency. A remote computer, such as in the cloud, can be used in order to do the training of the software and the storage, particularly of the images. The trained software can be handed over from the remote component of the computer 40 to its local component in order to be able to perform the labeling and the further consequences locally.

Any variation of the arrangement of the computer, or the number of computers and their common controlling and/or different components can be established as well.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be the preferred order, but it may not be mandatory to carry out the steps in the recited order. That is, unless otherwise specified or unless clear to the skilled person, the order in which steps are recited may not be mandatory. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1-15. (canceled)

16. A method for classification of objects in images, the method comprising:
obtaining a plurality of temporally sequential images;
detecting at least one object of interest in the images;
matching at least one detected object of interest across the plurality of the images;
applying variance analysis on the object between the temporally sequential images; and
based on variance analysis output, assigning at least one label to the object of interest.

17. The method according to claim 16, wherein the label identifies the object as at least one of an animate object or an inanimate object.

18. The method according to claim 17, wherein the inanimate object comprises an unmanned aerial vehicle.

19. The method according to claim 18, wherein the unmanned aerial vehicle is a drone.

20. The method according to claim 16, wherein the variance analysis comprises an Albedo variance analysis.

21. The method according to claim 20, wherein the Albedo variance analysis is a surface Albedo analysis.

22. The method according to claim 20, wherein the differentiation between the animate object and the inanimate object is performed by the Albedo variance analysis.

23. The method according to claim 22, wherein the differentiation between the animate object and the inanimate object is performed by the Albedo variance analysis, caused by morphing or unmorphing shapes.

24. The method according to claim 20, wherein the Albedo variance analysis can be performed in a static manner.

25. The method according to claim 20, wherein the Albedo variance analysis can be performed in a periodic manner.

26. The method according to claim 20, wherein the Albedo variance analysis can be performed in a statistical manner.

27. The method according to claim 20, wherein the Albedo variance analysis can be performed in a time-dependent manner.

28. The method according to claim 16, wherein the images are captured by pixel array image sensors and the variance analysis comprises the detection and/or measurement of light and/or light reflection by the pixel array image sensors over time.

29. The method according to claim 16, wherein the variance analysis has been trained by a convolutional neural network (CNN) for providing the label.

30. The method according to claim 16, further comprising:
prior to obtaining the images, recording a video of surroundings with at least one camera, wherein the temporally sequential images comprise consecutive frames of the video.

31. A system for classification of objects in images, the system being configured to:
obtain a plurality of temporally sequential images;
detect at least one object of interest in the images;
match at least one detected object of interest across the plurality of the images;
apply variance analysis on the object between the temporally sequential images; and
based on variance analysis output, assign at least one label to the object of interest.

32. The system according to claim 31, wherein the label identifies the object as at least one of an animate object or an inanimate object.

33. The system according to claim 32, wherein the inanimate object comprises an unmanned aerial vehicle.

34. The system according to claim 31, wherein the variance analysis comprises an Albedo variance analysis.

35. A computer program product comprising instructions, which, when the program is executed on a computer, causes the computer to perform the method steps according to claim 16.
